(19) United States
(12) Patent Application Publication
(10) Pub. No.: US 2010/0085949 A1
(43) Pub. Date: Apr. 8, 2010

(54) BASE STATION APPARATUS, AUTHENTICATOR APPARATUS AND METHOD FOR ATTACHING A BASE STATION APPARATUS TO AN AUTHENTICATOR APPARATUS

(75) Inventors: Achim von BRANDT, Munich (DE); Shun Liang Zhang, Beijing (CN); Yi Zhang, Beijing (CN); Wei Hua Zhou, Beijing (CN)

Correspondence Address: STAAS & HALSEY LLP, SUITE 700, 1201 NEW YORK AVENUE, N.W., WASHINGTON, DC, 20005, US

(73) Assignee: Nokia Siemens Networks Oy, Espoo (FI)

(21) Appl. No.: 12/534,553

(22) Filed: Aug. 3, 2009

Related U.S. Application Data
(60) Provisional application No. 61/085,617, filed on Aug. 1, 2008.

(51) Int. Cl. H04W 4/00

(52) U.S. Cl. 370/338

(57) ABSTRACT

A Base Station apparatus includes a network attachment device and a memory. The network attachment device is adapted to attach the Base Station apparatus to an Authenticator apparatus by sending a Base Station Attachment signal. The Base Station Attachment signal is adapted to request globally scoped or per-Base Station information from the Authenticator apparatus and the memory is adapted to store received globally scoped or per-Base Station apparatus information.

### CROSS REFERENCE TO RELATED APPLICATIONS

This application is based on and hereby claims priority to U.S. Provisional Application Ser. No. 61/085,617 filed on Aug. 1, 2008, the contents of which are hereby incorporated by reference.

### BACKGROUND OF THE INVENTION

The present invention relates to the technical field of communication networks.

Attaching a mobile device to a communication network may require a connection to an Authenticator in order to enable the terminal to access the communication network. The Authenticator may be the door opener to a back bone network.

From the document P802.16 Rev2/D3, “Part 16: Air Interface for Broadband Wireless Access Systems”, draft standard for local and metropolitan area networks, by IEEE Standards Activities Department, February 2008, an air interface, including the Medium Access Control layer (MAC) and Physical layer (PHY) of combined fixed and mobile point to multi-point Broadband Wireless Access (BWA) systems providing multiple services is known.

The document WiMAX™ Forum Network Architectures (Stage 3: Detailed protocols and procedures), release 1, version 1.2, Jan. 11, 2008, WiMAX™ Forum, describes detailed procedures, call flows, messages, timers, TLVs (Type Length Value) and attributes for the WiMAX™ end-to-end network specification.

Attaching a mobile station (MS) to an Authenticator may require translating layer 2 messages into higher layer messages, e.g. into messages according to the WiMAX™ Forum Standard, which may be included in a UDP package (User Datagram Protocol). On an initial network entry of an MS a communication with the Authenticator may have to be established. However, delays which appear during such a communication in the network may cause that timer in the MS terminate before a corresponding answer from the Authenticator may have been received. Therefore, the MS may continuously have to request the Authenticator for the corresponding information until the information can be received by the MS.

There may be a need to provide a more effective attaching of an MS to an Authenticator.

### SUMMARY OF THE INVENTION

The inventors propose a Base Station apparatus, an Authenticator apparatus, a method for attaching a Base Station apparatus to an Authenticator apparatus, a method for attaching a Terminal to an Authenticator apparatus, a program element, a computer-readable medium, the use of an MS_PreAttachment_Req message for transporting per-Base Station information, the use of an MS_PreAttachment_Rsp message for transporting per-Base Station information and the use of an MS_PreAttachment_Ack for transporting per-Base Station information.

According to an exemplary embodiment a Base Station apparatus may comprise a network attachment device and a memory. The network attachment device may be adapted to attach the Base Station apparatus to an Authenticator apparatus by sending a Base Station Attachment signal wherein the Base Station Attachment signal may be adapted to request per-Base Station information from the Authenticator apparatus. The memory may be adapted to store received per-Base Station apparatus information.

According to another exemplary embodiment, an Authenticator apparatus may be provided. The Authenticator apparatus may comprise a Base Station Attachment device. The Base Station Attachment device may be adapted to receive a Base Station Attachment signal from a base station and the Base Station Attachment device may further be adapted to transmit a globally scoped or per-Base Station apparatus information globally scoped or per-Base Station information to the Base station.

In other words, the Base Station may attach to the Base Station Attachment device and may receive information which the BS may distribute or re-distribute to an MS on behalf of the Authenticator.

Globally scoped information may mean information which is the same for all BS. I.e. when a plurality of BSs may attach to an Authenticator, the Authenticator may send the same information, e.g. Authenticator-related parameters or authorization policy support parameters to all BSs or to a predefined group of BSs. Thus, a plurality of BSs may receive the same information, which information each of the plurality of BSs may again transmit to MSs which may attach to that BS.

According to another exemplary embodiment, a method for attaching a Base Station apparatus to an Authenticator apparatus may comprise attaching a Base Station to an Authenticator by sending a Base Station Attachment signal to the Authenticator from a network attachment device of a Base Station apparatus. The method may further comprise requesting globally scoped or per-Base Station apparatus information from the Authenticator apparatus and receiving the globally scoped or per-Base Station apparatus information. Furthermore, the method may comprise storing the received apparatus information in a memory of the Base Station apparatus.

According to yet another exemplary embodiment, a method for attaching a Terminal to an Authenticator apparatus may be provided, which method may comprise receiving a Base Station Attachment signal in a Base Station Attachment device of the Authenticator apparatus. The method may further comprise transmitting a globally scoped or per-Base Station apparatus information to the Base Station apparatus.

According to another exemplary embodiment, a program element may be provided which, when being executed by a processor is adapted to carry out at least one of the method for attaching a Base Station apparatus to an Authenticator apparatus and/or the method for attaching a Terminal to an Authenticator apparatus.

According to another exemplary embodiment, a computer-readable medium may be provided on which a computer program may be stored which computer program, when being executed by a processor may be adapted to carry out at least one of the method for attaching a terminal to an Authenticator apparatus and the method for attaching a Base Station apparatus to an Authenticator apparatus.

A computer-readable medium may be a floppy disk, a harddisk, an USB (Universal Serial Bus) storage device, a RAM (Random Access Memory), a ROM (Read Only Memory), a flash memory or an EPROM (Erasable Programmable Read Only Memory). The computer-readable medium may also be a data communication network, e.g. the Internet, which may allow downloading a program code.

According to yet another exemplary embodiment the use of at least one message selected from the group of messages consisting of an MS_PreAttachment_Req message, an MS_PreAttachment_Rsp message and an MS_PreAttachment_Ack message for transporting globally scoped or per-Base Station apparatus information may be provided.

Using these messages for transporting globally scoped or per-Base Station apparatus information may comprise providing an MS_PreAttachment_Req message, providing an MS_PreAttachment_Rsp message and/or providing an MS_PreAttachment_Ack message and using these messages for transporting globally scoped or per-BS information. Furthermore, a lease value may be distributed using these messages.

Furthermore, other messages which may have a similar functionality, scope or structure as an MS_PreAttachment_Req message, an MS_PreAttachment_Rsp message and an MS_PreAttachment_Ack message may be used for transporting globally scoped or per-Base Station apparatus information.

An MS may also be a terminal, a mobile station, a subscriber station, an SS, a user terminal or a mobile device.

Requesting a globally scoped information, a per-Base Station (BS) apparatus information or a per-BS information may mean that a BS may try to connect to the Authenticator and may request and receive information or parameter from the Authenticator that is applicable to all Base Stations, a subset of all Base Stations or only for that particular BS. I.e. the BS may store the information from the Authenticator and may use this information substantially independently from the Authenticator. Thus, providing the corresponding information to a MS by the BS may become possible and a per-Mobile Station access or a per-MS access may be prevented. In other words, the process of attaching an MS to a BS may be decoupled from the process of attaching a BS to an Authenticator. Thus, communicating between BS and MS may be independent from communicating between BS and Authenticator.

A per-MS access to the Authenticator may mean that every MS would have to request the information from the Authenticator individually.

An MS, which may want to access a communication network may have to be authenticated and authorized in the communication network, in order to get a desired access, a desired access level or a desired QoS (Quality of Service). In a particular embodiment access may be requested on an initial network entry or on a network re-entry, which may be triggered either by MS handover e.g. a mobility event, or by MS state change from Idle to Active, or for any other reason may be specified by the WiMAX™ standard. Every time the MS may execute network initial entry in a per-MS based scenario, a Base Station, a Base Station apparatus or a BS may acquire or negotiate Authenticator-related parameters from or with the Authenticator for this particular MS. Often, procedures executed on initial entry may base on such a per-MS mechanism. In other words, a per-MS mechanism may be a mechanism or a procedure, which may be conducted or processed for each MS individually on e.g. initial network entry.

Thus, every MS seeking for initial entry or seeking for access to a communication network may request authorization policy support parameter from an Authenticator.

However, authorization policy support parameter may be configured in the Authenticator on a per-Authenticator basis. I.e. the Authenticator may send for each MS the same authorization policy support parameter.

In contrary to this, authorization policy support parameter retrieval may base on the per-MS mechanism. The per-MS mechanism may comprise, that the BS may conduct a pre-attachment procedure for every initial entry of an MS. This provision of authorization policy support parameter may be provided for each individual MS even if the Authenticator may substantially always response the same authorization policy support parameter to the BS. During the pre-attachment procedure, an SS (Subscriber Station) basic capability determining procedure may be interrupted.

According to yet another exemplary embodiment Authenticator-related parameters may be provided with one or more rules which rules may allow selecting a subset of MSs out of all MSs such, that these parameters may only apply for the selection of MSs. Such rules may be based either on MS Identification (MSID), or MS affiliation (specific operator or roaming scenario), or any other principle. In such case MS network entry may be viewed as with per-MS authorization, while in fact BS may respond to the MS directly on behalf of the Authenticator, but such response may vary between different MSs. In other words, for the MS accessing the network the authorization may seem to be on a per-MS basis with the Authenticator. However, the BS may handle the access procedure of the MS and may respond directly to the MS. Thus, the BS may conduct a functionality of the Authenticator. How the BS may react, in particular, which MS may get which access policy or which Authenticator-related parameter may be controlled by rules. These rules may be distributed by the Authenticator. In particular, the Authenticator may distribute the Authorization-related parameters as well as a rule. Thus, the Authenticator may distribute different Authorization-related parameters for different MSs, thus BS may respond to requests of different MSs with different policies.

The rules may define in a BS for which MSs the BS may be allowed to apply the Authorization-related parameters. The rules may provide different access scenarios for different MSs, thus the response of the BS to requests of different MSs may vary and may depend on the MS. The rules may be such that for some of the MSs, the rules may tell the BS that it shall not send SBC-RSP autonomously to the respective MS but may need to perform the MS_PreAttachment procedure first, to get new Authorization Policy Support parameters from the Authenticator, before sending SBC-RSP to the MS.

Providing or retrieving Authenticator-related parameters or authorization policy support parameter on a per-BS basis may allow reducing the number of requests in the direction to the Authenticator apparatus.

In a per-BS mechanism, a BS (Base Station) may pre-fetch the Authenticator-related parameters in advance, e.g. parameters such as an Authenticator identifier (ID) or authorization policy support parameter. I.e. the BS may negotiate corresponding parameters, e.g. Authenticator-related parameters with the Authenticator prior to attaching an MS to the BS. Therefore, the BS may request from a network entity as for example from the Authenticator in advance the Authenticator-related parameters. The received parameters may be used for all MSs, which may access an access service network (ASN) through this particular BS after the BS may have negotiated the corresponding parameters with the Authenticator. The Authenticator-related parameters may be valid for a predefined lease value. The parameters may also be valid for a predefined time. In other words, for example a BS may be connected to the ASN and the BS may allow an MS to connect to the Authenticator via the BS. The Authenticator-related parameters or the authorization policy support parameter may be stored, administrated and used by the BS on behalf of the Authenticator until these parameters may be updated or until a lease value or a lease time may expire. Thus, every MS may receive actual and up-to-date parameters associated with the corresponding Authenticator apparatus.

If a parameter may change, the new parameter may apply to new initial entries of MSs without having impact to MSs which may already have been connected via the BS to the Authenticator. Thus, negotiating the parameters with the Authenticator before sending corresponding parameters to the MS may be prevented. For example, an MS may use a SBC-REQ message (Subscriber Station (SS) Basic Capability Request) for initialization and for requesting parameters.

Authorization policy support parameter or Authenticator-related parameters may be provided from the BS to the MS with an SBC-RSP (SS Basic Capability Response) message as one of the embodiments. Loading the parameters to the BS prior to receiving SBC-REQ may prevent to request the Authenticator before the SBC-RSP message may be sent to the MS and after the SBC-REQ message may have been received.

Attaching the Terminal or the MS to the BS or to an Authenticator may mean logically attaching the MS to the BS or to the Authenticator apparatus. I.e. a link or an association between corresponding MS and BS, BS and Authenticator apparatus or MS and Authenticator apparatus may be made by storing corresponding IDs as for example corresponding MS info. MS info may comprise MS-related context.

Thus, attaching the BS to the Authenticator apparatus may also mean linking the Base Station apparatus with an Authenticator apparatus, e.g. by establishing a tunnel between Base Station apparatus and Authenticator apparatus. Attaching may also mean negotiating parameters, for example authentication policy support parameter or Authenticator-related parameters. Attaching may also mean storing a common context or a common identifier (ID) in at least two apparatus. By the common ID detecting of the association on each of the at least two apparatus may be possible.

According to another exemplary embodiment, the Base Station apparatus, in particular the network attachment device, may be further adapted for receiving a Base Station Update signal. The Base Station Update signal may comprise updated globally scoped or per-Base Station apparatus information. The memory may be adapted to store the updated globally scoped or per-Base Station apparatus information.

Thus, the memory may substantially comprise updated globally scoped or per-Base Station apparatus information, e.g. authorization policy support parameters or Authenticator-related parameters. The globally scoped or per-Base Station apparatus information may be determined by the Authenticator apparatus, independently from a request or an initial entry of an MS. Thus, the Authenticator apparatus may trigger the Base Station apparatus by sending the update information. The method of attaching a BS to an Authenticator apparatus may be independent from the method of updating information stored in the BS. Thus, the methods may be processed by separate Authenticator apparatus.

According to another exemplary embodiment, the Base Station apparatus may further comprise a Terminal attachment device. The Terminal attachment device may be adapted to allow a Terminal attaching to the Authenticator apparatus via the network attachment device and/or via the terminal attachment device after globally scoped or per-Base Station apparatus information may have been received by the network attachment device.

In an example the Base Station may regularly receive updated information and may identify that information may be available in the memory. Attaching of an MS to a BS before Authenticator policy support parameter or Authenticator related parameters are available in the memory may be refused by the BS.

According to another exemplary embodiment, attaching the Terminal to the Authenticator apparatus may comprise sending the globally scoped or per-Base Station apparatus information to the Terminal. The globally scoped or per-Base Station apparatus information may be sent to the Terminal using the SBC-RSP message as one embodiment. In such embodiment the initial entry of an MS may be signalled by sending an SBC-REQ message to the BS.

Attaching the Terminal to the Authenticator apparatus may also comprise establishing a tunnel, an association or a logical link between the Terminal and the Authenticator, for example storing corresponding Ids, e.g. corresponding MS info. MS info may comprise MS-related context.

According to yet another exemplary embodiment, attaching the Terminal to the Authenticator apparatus may comprise sending a Terminal identification signal by the network attachment device to the Authenticator apparatus.

Without limiting the scope of the proposals, a Terminal identification signal, for example may be performed by an MS_PreAttachment_Req (MS Pre-Attachment Request) from the BS to the Authenticator. In such an example, the BS may send the MS_PreAttachment_Req message to its default Authenticator in order to inform the default Authenticator about a new MS entering the network.

According to another exemplary embodiment, the Base Station apparatus may be at least a Base Station selected from the group consisting of a WiMAX™ Base Station, an IEEE 802.16 Base Station, an IEEE 802.16E Base Station, a GSM Base Station (Global System for Mobile communications), and an UMTS (Universal Mobile Telecommunications System) Base Station. An IEEE 802.16 Base Station is a Base Station, which uses the IEEE 802.16 standard. Furthermore a Base Station may be of any BS size, and the Base Station may be as an example a femto Base Station, a pico Base Station, a macro Base Station or others.

According to another exemplary embodiment, the Base Station Attachment signal may be a BS_Attachment signal and/or the Base Station update signal may be a BS_Update signal.

For example, a BS_Attachment_Req (BS_Attachment_Request) message and a BS_Attachment_Rsp (BS_Attachment_Response) message may be defined in order to communicate between BS and Authenticator to attach the BS to the Authenticator or to establish an association between BS and Authenticator.

According to another exemplary embodiment of the invention for updating authorization parameters the Authenticator may use a BS_Update_Req (BS_Update_Request) message and a BS_Update_Rsp (BS_Update_Response) message.

The BS_Attachment signal may comprise in such embodiment the BS_Attachment message and the BS_Update signal may comprise a BS_Update message.

In another exemplary embodiment, an MS_PreAttachment_Req message and an MS_PreAttachment_Rsp message, which may be defined in the WiMax™ standard, may be used or reused in order to communicate between BS and Authenticator to attach the BS to the Authenticator or to establish an association between BS and Authenticator. Some modification may have to be made to an existing message.

Thus, in this exemplary embodiment the MS_PreAttachment_Req message may be used as a BS_Attachment_Req message and the MS_PreAttachment_Rsp message may be used as a BS_Attachment_Rsp.

In another exemplary embodiment, an unsolicited MS_PreAttachment_Rsp message and an MS_PreAttachment_Ack message may be reused for updating the authorization-related parameters on BS. In other words, a BS receiving an MS_PreAttachment_Rsp without having sent an MS_PreAttachment_Req may interpret the unsolicited MS_PreAttachment_Rsp as a BS_Update_Req message comprising a lease value. This may indicate to the BS to update the Authorization Policy Support value and lease value. Furthermore, an MS_PreAttachment_Ack received by the Authenticator may be used as a BS_Update_Rsp message.

According to another exemplary embodiment, the Terminal attachment device of the Base Station apparatus may be adapted to allow a further Terminal attaching to the Authenticator apparatus via the Terminal attachment device. Attaching the further terminal to the Authenticator apparatus may comprise sending actual per-Base Station apparatus information to the Terminal.

The actual globally scoped or per-Base Station apparatus information may be an amended, an up-to-date or updated entry in the memory of the globally scoped or per-Base Station apparatus information. Thus, a Terminal which may desire to attach to an Authenticator apparatus may receive the actual or latest parameters available for the corresponding Authenticator or the default Authenticator.

According to another exemplary embodiment, the process of attaching the Base Station apparatus to the Authenticator apparatus may be separated from the process of attaching the Terminal to the Authenticator apparatus.

Thus, the BS may receive the actual or latest parameters from the Authenticator independently from providing access for an MS to the Authenticator apparatus. In other words, the process of attaching the Base Station apparatus to the Authenticator apparatus may be decoupled from the process of attaching the Terminal to the Authenticator apparatus.

According to another exemplary embodiment, the Base Station Attachment device of the Authenticator may further be adapted to attach the Authenticator apparatus to a Base Station and vice-versa.

Thus, the Base Station and the corresponding Authenticator or the default Authenticator may establish an association between one another which at least logically link the Authenticator apparatus with the Base Station apparatus.

According to another exemplary embodiment, the Base Station Attachment device may be further adapted to transmit a Base Station Update signal to the Base Station upon amending a predefined parameter within the Authenticator apparatus. The Base Station update signal may comprise updated globally scoped or per-Base Station apparatus information, e.g. authorization policy support parameter and/or Authenticator-related parameters.

The Authenticator apparatus may inform the Base Station about amendments of parameters relevant for the Base Station, without the Base Station may have to request the Authenticator apparatus for updated information. Therefore, the information stored in the Base Station, may substantially be up-to-date. Storing the updated information may allow providing a Terminal with up-to-date authorization policy support parameter or Authenticator-related parameters.

According to another exemplary embodiment, the globally scoped or per-Base Station apparatus information may comprise Authorization Policy Support parameter and/or Authenticator-related parameters.

For example the Authorization Policy Support parameter may comprise EAP (Extensible Authentication Protocol) information and/or RSA information. An EAP information may comprise at least information selected from the group of information consisting of a user identification, a message such as an authentication error, a NAK (No Acknowledge/Negative Acknowledge), a MD5-Challenge (Message Digest Algorithm), a one-time password and a TLS (Transport Layer Security).

The information transmitted as an Authorization Policy Support parameter from the Authenticator to the BS as a globally scoped or per-BS information may be sent from the BS to a corresponding MS.

According to a further exemplary embodiment the Authorization Policy Support parameter and/or other authorization-related parameters may have a lease value. The lease value may be associated with the Authorization Policy Support parameter and/or other authorization-related parameters and may provide for a duration of validity for the same.

In other words, together with the Authorization Policy Support parameter or the globally scoped or per-BS information a lease value may be distributed. This lease value may indicate to the receiver the duration of how long the Authorization Policy Support parameter or any other transmitted parameter may be valid and may be used.

Thus, a BS may know, how long an Authorization Policy Support parameter may be used for distributing it to a corresponding MS. For example, the lease value may be a time duration, a time period or a lease time, or the lease value may also be a number, e.g. a limited number of MS for which a particular Authorization Support parameter may be used.

E.g. the lease time may be one hour or any plurality thereof. Then, every MS requesting access via the BS within this number of hours beginning from the time of receipt of the Authorization Policy Support parameter may get access by using this Authorization Policy Support parameter.

As another example in the case of a limited lease number, maybe the next 100 MS may get access by using the Authorization Policy Support parameter associated with this lease number.

The BS may administrate the lease value and may trigger the renewal of the lease value and a corresponding Authorization Policy Support parameter and/or other authorization-related parameters.

The Authenticator may send a lease value if the Authenticator may know that the Authorization Policy Support parameter will not change over a certain predefined time. Thus, the Authenticator may control and respectively regulate a BS. In particular, the Authenticator may control respectively regulate the update process or the update method for a parameter, in particular, for the Authorization Policy Support parameter.

In one exemplary embodiment the globally scoped or per-BS information may comprise the lease value, i.e. a message, such as the BS_Attachment_Req message, the BS_Attachment_Rsp message, the BS_Update_Req message, the BS_Update_Rsp message, the MS_PreAttachment_Req message and/or the MS_PreAttachment_Rsp message may comprise the lease value. Thus, a per-BS information message, a Base station Attachment signal or a Base Station update signal may comprise a TLV for transmitting a lease value.

The method or procedure for receiving in a BS an Authorization Policy Support parameter from an Authenticator exist and the method or procedure for providing the Authorization Policy Support parameter to an MS by the BS may exist according to an exemplary embodiment. The lease value may allow decoupling these two methods.

According to another exemplary embodiment, the Authenticator apparatus may further comprise a remote Terminal attachment device, wherein the remote Terminal attachment device may be adapted to allow at least one Terminal attaching to the Authenticator apparatus.

The remote Terminal attachment may allow attaching at least one Terminal or a plurality of Terminals to the Authenticator apparatus at the same time.

According to yet another exemplary embodiment, the Authenticator apparatus may be at least one apparatus selected from the group consisting of an Authenticator, an Access Service Network Gateway (ASN-GW), a visited Authentication, Authorization and Accounting (AAA) server (Authentication, Authorization, Accounting) and a home AAA server or other relevant WiMAX™ network elements or functional entities.

The function of an Authenticator apparatus may be integrated in but not limited to an ASN gateway, in a visited AAA server or in a home AAA server.

According to another exemplary embodiment, the method for attaching a Base Station apparatus to an Authenticator apparatus may further comprise receiving a Base Station Update signal in the network attachment device, wherein the Base Station Update signal may comprise updated per-Base Station apparatus information. The method may further comprise storing the updated per-Base Station apparatus information in the memory of the Base Station.

According to another exemplary embodiment, the method for attaching a Terminal to an Authenticator apparatus may further comprise detecting the amendment of a predefined parameter within the Authenticator apparatus. If such an amendment or modification may be detected, a Base Station Update signal may be transmitted to a Base Station, wherein the Base Station Update signal may comprise updated globally scoped or per-Base Station apparatus information. The updated globally scoped or per-Base Station apparatus information may be stored in the memory.

According to another exemplary embodiment, the method for attaching a Terminal to an Authenticator apparatus may further comprise detecting amending of a predefined parameter within the Authenticator apparatus. The method may further comprise transmitting a Base Station update signal to a Base Station, wherein the Base Station update signal may comprise updated globally scoped or per-Base Station apparatus information.

It has also to be noted that embodiments and aspects of the proposals may have been described with reference to different subject-matters. In particular, some embodiments may have been described with reference to an apparatus whereas other embodiments may have been described with reference to a method. However, a person skilled in the art may gather from the above and the following description that unless other notified in addition to any combination between features belonging to one type of subject-matter also any combination between features relating to different subject-matters, in particular between features of the apparatus and the features of the method, may be considered to be disclosed with this application.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a communication system comprising an MS, a BS and an Authenticator according to an exemplary embodiment of the inventors' proposals.

FIG. 2 shows an extract of a flow-chart of a method for an MS initially entering an access network for a better understanding of the proposals.

FIG. 3 shows a flow-chart for a method for attaching a BS to an Authenticator on a per-BS basis according to an exemplary embodiment of the inventors' proposals.

FIG. 4 shows a flow-chart for a method for attaching an MS to an Authenticator according to an exemplary embodiment of the inventors' proposals.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

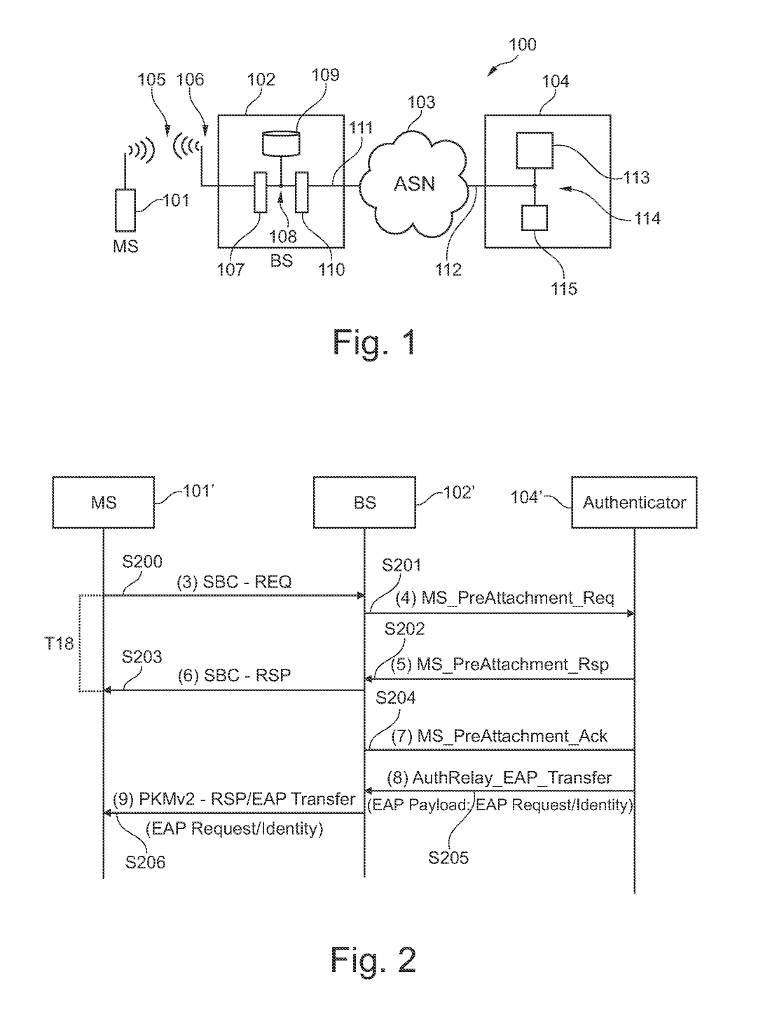

FIG. 1 shows the communication system 100 comprising the MS 101, the BS 102, the ASN 103 and the Authenticator 104. The MS 101 uses the air interface 105 to connect to the BS 102, in particular to connect to the antenna 106 of the BS 102. The BS 102 comprises the Terminal attachment device 107, which is connected to the antenna 106. The Terminal attachment device 107 in combination with antenna 106 allows to connect the MS with the Base Station 102. The Terminal attachment device 107 allows the MS 101 to be connected to the BS 102. A connection between the MS 101 and the BS 102 may be an association of the MS or a context of the MS stored in the Terminal attachment device 107.

The Terminal attachment device 107 is physically connected with the connecting network 108 to the memory 109, cache 109 or storage 109. Furthermore, the Terminal attachment device 107 and the memory 109 are connected to the network attachment device 110.

The network attachment device provides the network interface 111, which allows physically connecting the network attachment device 110 to a corresponding access service network (ASN) 103. The access service network 103 may be an IP (Internet Protocol) network, for example the Internet. Via the ASN 103 the BS 102 is connected with the network interface 112 to the Authenticator 104 or the Authenticator apparatus 104. In an example the Authenticator 104 may be comprised by an ASN-GW or may be collocated with an ASN-GW. Furthermore, the BS 102 may also be comprised by the ASN 103. The ASN 103 may be a transport network.

The Authenticator apparatus 104 may allow an access for the MS 101 to a visited AAA server or a home AAA server, which are not shown in FIG. 1.

The Authenticator apparatus 104 comprises the Base Station attachment device 113 which is physically connected via the links 114 to the remote Terminal attachment device 115.

The remote Terminal attachment device 115 may allow to establish a communication relation or an association between the MS 101 and the Authenticator apparatus 104. Thus, the remote Terminal attachment device 115 may store MS related context whereas the Base Station attachment device 113 may store Base Station related context. By storing context an association between devices may be made.

The air interface 105 may correspond to the R1 reference point and the interfaces 111 and 112 may correspond to the R6 reference point.

FIG. 2 shows an extract of a flow-chart of a method for an MS initial network entry procedure for a better understanding of the proposals.

The location of the MS 101 is represented by box 101′ or time line 101′. The location of the BS 102 is represented by the box 102′ or time line 102′ and the location of the Authenticator 104 is represented by the Authenticator box 104′ or time line 104′. Not shown in FIG. 2 is the DL (Downlink) synchronization and UL (Uplink) synchronization between MS 101′ and BS 102′. Downlink synchronization and uplink synchronization is made on network layer 2 to establish a peer-to-peer connection between MS 101′ and BS 102′ and is made in accordance to the standard IEEE 802.16.

After the MS 101′ obtains DL synchronization and UL synchronization in step S200 the MS 101′ sends an SBC-REQ message to start the basic capabilities negotiation. Among the capability negotiation parameters, only Authorization Policy Support parameter need to be negotiated with the Authenticator 104 by MS_PreAttachment_REQ and MS_PreAttachment_RSP messages. In other words, MS 101′ sends the SBC-REQ message for starting basic capability negotiation, where MS 101′ and BS 102′ among other parameters negotiate the PKM (Privacy Key Management) protocol version, Authorization Policy and message authentication code mode. The SBC-RSP message in step S203 can only be sent after in step S201 the MS_PreAttachment_REQ message has been sent from BS 102′ to Authenticator 104′ and in step S202 the MS_PreAttachment_RSP message has been received by the BS 102′.

After receiving the SBC-REQ message the BS 102′ in step S201 the MS Pre-Attachment procedure starts to negotiate the Authorization Policy Support with the Authenticator 104′. The MS Pre-Attachment procedure which may comprise sending MS_PreAttachment_REQ and receiving MS_PreAttachment_RSP by BS 102′ may allow to inform the Authenticator 104′ about MS 101′ for a later attachment or negotiation between MS 101′ and Authenticator 104′.

The BS 102′ in step S202 may receive Authorization Policy Support parameter and the BS 102′ includes the received Authorization Policy Support parameters and the capability parameter owned by the BS 102′ into a SBC-RSP message, which the BS 102′ sends to the MS in step S203. The content of the SBC-RSP message indicates the results of the capability negotiation of steps S201 and S202.

If the delay between sending the SBC-REQ message in step S200 and receiving the SBC-RSP message in step S203 is much longer than the default value of a corresponding timer T18 (which is shown in FIG. 2) then the timer T18 will expire. For example, the timer T18 may expire after 50 ms (milliseconds).

The expiration of the timer T18 may cause the MS 101′ to resend the SBC-REQ message of step S200 continuously, which may increase the signaling load of the air interface 105.

In step S204 a MS_PreAttachment_ACK (MS_PreAttachment_Acknowledge) message is sent from the BS 102′ to the Authenticator 104′. Thus, the BS 102′ confirms to the Authenticator 104′ that SBC-RSP message has been sent to the MS 101′.

In step S205 the Authenticator 104′ initiates an EAP (Extensible Authentication Protocol) authentication procedure with MS 101′. The trigger for it is the successful end of the MS_PreAttachment transaction in step S204. The Authenticator 104′ sends an EAP request/identity message or an EAP request/identity message over authentication relay protocol (AR EAP T) to BS 102′.

In step S206 the BS 102′ relays the EAP request/identity payload (received in AR EAP Transfer message) in the PKM V2-RSP/EAP-Transfer message to the MS 101′.

In a first case a Network Discovery & Selection (ND&S) may be conducted. The MS 101 may use SBC-REQ messages which may contain a SIQ (Service Information Query) TLV to require an NSP (Network Service Provider) list or a verbose NSP name list from BS 102. The SBC-REQ may comprise an SIQ TLV in order to request the Service Network Provider Identifier supported by the operator network that includes the current BS. The NSP list or verbose NSP name list may be available in the BS 102 and thus BS 102 may respond with SBC-RSP to the request of MS 101 directly, i.e. without requesting the Authenticator 104. This response may be sent within T18 timeout, i.e. without expiration of the T18 timer. Thus, for ND&S which may only be a request no authentication may be required.

In a case of an initial network entry or a network re-entry, e.g. after a handover of the MS from one cell to another, an authentication may be required. Thus, in the initial network entry case or the network re-entry case the SBC-REQ message may not comprise a SIQ TLV. Since the SBC-REQ message may not comprise the SIQ TLV however, the SBC-REQ message may comprise some parameters which need to be negotiated with BS and Authenticator, the reception of the SBC-REQ message without the SIQ TLV can indicate to the Base Station to start the basic capability negotiation procedure via ASN 103, in particular with the Authenticator 104. In other words, the fact that an SBC-REQ message has been received by the BS, wherein the SBC-REQ message may comprise physical parameters supported by the BS, and at the same time the SBC-REQ message may not comprise an SIQ TLV value, indicates to the BS to start the basic capability negotiation procedure. A missing SIQ TLV may be indicated by setting bits “0” and “1” of SIQ TLV to zero. Thus, the steps S201, S202 may have to be processed before SBC-RSP message can be sent from BS 102 to MS 101.

Different values for the T18 timer may be provided depending on the purpose of the SBC-REQ message. In the ND&S case a shorter value for the T18 timer may be used than in the case of an initial network entry or a network re-entry.

Another idea may be to decouple the communication between the MS and the BS from the communication between the BS and the Authenticator. Thus, a per-BS information may be provided by the Authenticator. I.e. the Authenticator may provide information or parameters to the BS independently from a request of an MS. Therefore, the parameters may be available in the BS 102, before a MS 101 requests attaching to the BS 101.

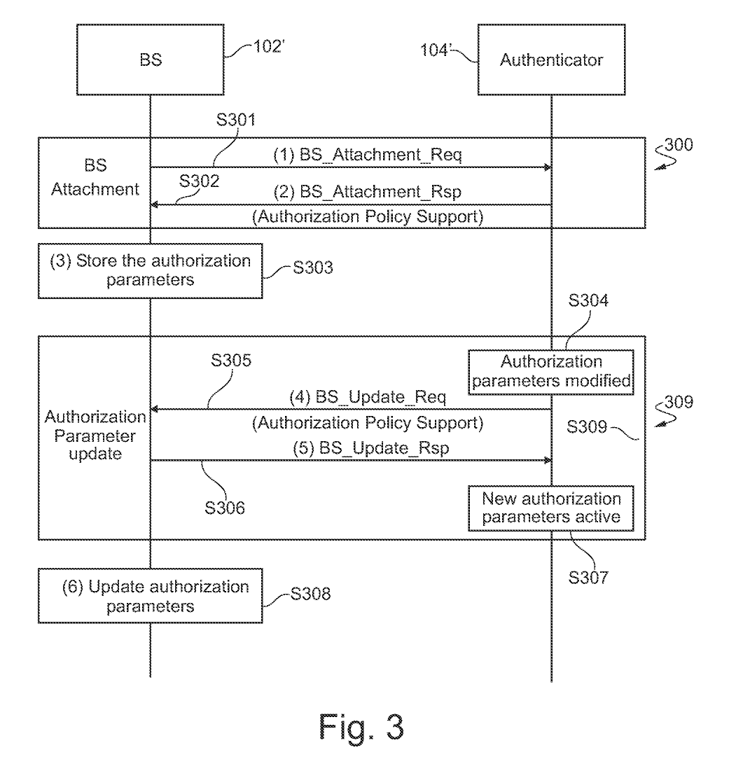

FIG. 3 shows a flow-chart for a method for attaching a Base Station BS 102′ to the Authenticator 104′ on a per-BS basis. I.e. the BS 102′ may be adapted for requesting per-BS information from the Authenticator 104′ or Authenticator apparatus 104′.

Block 300 comprises two steps for providing per-BS information to the BS 102′. As shown in block 300 by conducting steps S301 and S302 it may be prevented that the BS 102′ acquire from the Authenticator 104′ or that the BS negotiate the Authenticator-related parameters with the Authenticator 104′ for every initial entry of a MS to an ASN 103. Thus, a per-MS negotiation may be prevented. Such a per-MS mechanism may be prevented by independently attaching a BS 102′ to an Authenticator 104′.

The Authorization Policy Support parameters may be configured on a per-Authenticator basis. If the Authorization Policy Support parameters however are requested on a per-MS mechanism delay may be generated. In other words, the BS 102′ may conduct steps S201 and S202 for every MS initial entry although the Authenticator 104′ may always respond the same Authorization Policy Support parameters for the BS requesting the parameters.

Thus, in FIG. 3 the provision of Authorization Policy Support parameters is made on a per-BS basis. In FIG. 3, in particular in block 300 of FIG. 3 Authenticator-related parameters are retrieved on a per-BS basis. In the per-BS mechanism 300 the BS 102′ will pre-fetch the Authenticator-related parameters in advance.

For pre-fetching the Authenticator-related parameters in step S301 the BS 102′ sends a BS_Attachment_REQ message (BS_Attachment_Request) to Authenticator 104′. The Authenticator 104′ in step S302 responds with a BS_Attachment_RSP message comprising Authorization Policy Support parameters for the corresponding BS 102′. Thus, block 300 describes a BS attachment to the Authenticator 104′.

Pre-fetching may mean negotiating parameters before a communication with an MS 101 is allowed.

The Authorization Policy Support parameters or Authenticator-related parameters may be used for all MSs 101, 101′ (not shown in FIG. 3) which may access the ASN through the corresponding BS 102′. The ASN in FIG. 3 is represented by the Authenticator 104.

One example for generating a BS_Attachment_Req message may be using the MS_PreAttachment_Req message body in combination with a message header according to the WiMax™ Stage 3 specification, wherein the MS ID (MS identifier) field is set to the logical value zero or to “0” (MS ID=“0”). The message header according to the WiMax™ Stage 3 specification may comprise a Version field, a Flag field, a Function Type field, an Operation Type field, a Length field, an MS ID field, a Reserved field, a Transaction ID field and a further Reserved field. Thus, in this example providing the per-BS information may comprise setting the MS ID field to zero.

Similarly, one example for generating a BS_Attachment_Rsp message may be using the MS_PreAttachment_Rsp message by setting the MS ID field to zero.

In step S303 the received Authorization Policy Support parameters are stored in the memory 109 of BS 102′ (the memory is not shown in FIG. 3). In other words, once the Authorization Policy Support parameters are stored in the BS 102′, the corresponding Authorization Policy Support may be used for a corresponding MS 101.

If the Authorization Policy Support parameters in the Authenticator 104 may be amended or modified in step S304, this modification may be determined within the Authenticator 104′.

Such an amendment may be up to an operator of a network. I.e. the operator may decide about implementing such an amendment of parameters. E.g. the operator may decide to replace EAP by RSA (Rivest, Shamir, Adleman). For informing the BS about these amendments, the operator may conduct the update procedure 309 and provide amended Authorization Policy Support parameters as per-BS information.

When the parameters have been changed, amended or modified, the amended parameters or the new parameters in step S305 are sent in a BS_Update_REQ (BS Update Request) message to the BS 102′, in particular to the memory 109 of BS 102′. Thus, the Authorization Policy Support parameters or authorization parameters in the memory of the BS 102′ are updated. The reception of the BS_Update_REQ message is acknowledged by a BS_Update_RSP (BS_Update_Response) message in step S306.

When the Authenticator 104′ receives the BS_Update_RSP message the Authenticator is informed that the new authorization parameters are active as depicted in step S307.

Box 309 in FIG. 3 comprise the authorization parameter update procedure. After the steps S305 and S306 have been processed, updated authorization parameters are available in BS 102′ as shown in step S308. Thus, the updated authorization parameters are used for all MS which access the ASN through the corresponding BS 102 as an initial entry. The update may not impact the parameters of MS which already have been authorized in the ASN. Therefore, it may be prevented to negotiate with the Authenticator 104′ after the SBC-REQ message has been received and the SBC-RSP message can immediately after receipt of SBC-REQ message be sent. In other words, the BS 102′ can send a message, e.g. a response message, in the direction to the MS 101′ before the BS 102′ sends a message, e.g. a request message, in the direction to the Authenticator 104′.

During the update steps S305 and S306, the BS may prevent attaching of new MSs.

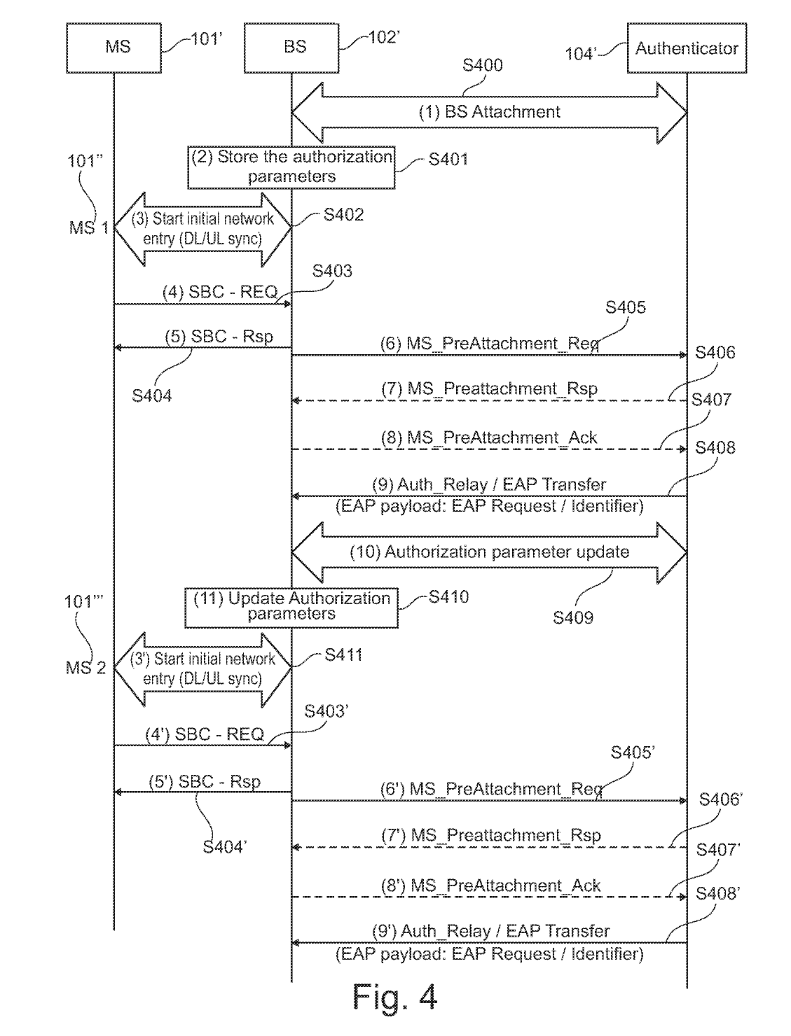

FIG. 4 shows a flow-chart for a method for attaching a BS to an Authenticator on a per-BS basis according to an exemplary embodiment. In FIG. 4 again the MS 101′, the BS 102′ and the Authenticator 104′ are shown. In the per-BS mechanism S400 the messages BS_Attachment_REQ, BS_Attachment_RSP, BS_Update_REQ and BS_Update_RSP are defined.

The BS_Attachment_REQ message may be a signal sequence triggering the Authenticator 104′ to provide Authorization Policy Support parameters.

The BS_Attachment_RSP message may be a signal sequence comprising the Authorization Policy Support parameters.

The BS_Update_REQ message may be a signal sequence which is triggered by the Authenticator 104′ on modification of authorization parameters.

This signal sequence BS_Update_REQ is sent from the Authenticator 104′ to the BS 102′ and comprises Authorization Policy Support parameters.

The BS_Attachment_REQ message, the BS_Attachment_RSP message, the BS_Update_REQ message and/or the BS_Update_RSP message may comprise a lease value.

The BS_Update_RSP is a signal sequence which is sent from BS 102′ to Authenticator 104′ and signals to the Authenticator 104′ that new authorization parameters are active.

If the BS 102 is attached to the ASN 103 the BS tries to attach to the possible Authenticators 104 and to receive from a corresponding Authenticator or from a default Authenticator 104 corresponding Authorization Policy Support parameters before an MS is attached to the corresponding BS. In other words, the BS may prevent attaching an MS to the BS before the BS 102 has not received Authorization Policy Support parameters.

After the BS is attached to the Authenticator 104 the Authenticator 104 responds to the BS 102 with authorization parameters or Authorization Policy Support parameters.

If within the Authenticator 104 the authorization parameters are modified or updated, if a BS 102 already has been attached to an Authenticator 104 and if the Authenticator 104 decides to change the authorization parameters the Authenticator triggers the update procedure. In the update procedure 309, S409 the Authorization Policy Support parameters in the BS are updated. The new authorization parameters in the Authenticator 104′ are immediately activated after receiving the BS update RSP message in step S306. In other words, the Authenticator 104′ does not activate new authorization parameters before the BS_Update_RSP message has been received.

In step S400 the BS 102′ attaches to the Authenticator 104′ to get related authorization parameters. The procedure which is conducted in step S400 corresponds to the BS attachment procedure of block 300 in FIG. 3.

In step S401 the BS 102′ stores assigned Authenticator parameters and related authorization parameters.

In step S402 an MS1 101″ starts an initial network entry procedure. The initial network entry procedure is initiated by a DL synchronization and/or UL synchronization on layer 2 between MS 101′ and BS 102′.

After the initial network entry procedure of step S402 in step S403 the SBC-REQ message is sent from MS1 101″ to BS 102′ to start the basic capability negotiation with the BS.

In step S404 immediately after having received the SBC-REQ message the BS 102′ can reply with an SBC-RSP message without having to wait for corresponding MS_PreAttachment_REQ S405, MS_PreAttachment_RSP S406 and MS_PreAttachment_ACK messages S407. Thus the timer T18 may not expire.

In step S405 the BS 102′ sends MS_PreAttachment_REQ to Authenticator 104′. In step S406 the Authenticator 104′ replies with MS_PreAttachment_RSP and in step S407 the BS 102′ sends a MS_PreAttachment_ACK to Authenticator 104′. Thus, BS 102′ does MS_PreAttachment for MS1 with the assigned Authenticator 104′.

In order to reduce the total network discovery and selection (ND&S) time and to improve the system performance steps S406 and step S407 may be omitted.

Since Authorization Policy Support has been obtained by BS 102′ in advance, i.e. in step S401, the MS PreAttachment procedures function may be only used to create a new context for the MS ID (MS Identification) for MS1. Thus, step S406 and step S407 may be omitted. Step S408 which is an Auth_Relay/EAP Transfer, may work as a feedback of step S405.

After step S408 in step S409 the Authenticator 104′ may update the authorization parameters. As a consequence of this update, in step S409, which corresponds to box 309 the Authenticator 104′ updates the authorization parameters.

Thus, in step S410 updated authorization parameters are available in BS 102′.

Therefore, if the MS2 101″′ in step S411 starts an initial network entry procedure, the new authorization parameters will be used, which are derived in step S409.

Thus, it may be prevented that timer T18 expires before SBC-RSP message may be sent to the MS. Decoupling the BS attachment and the MS attachment procedure may prevent to amend the air interface between MS and BS and thus may allow an easy implementation for proposed method. The timer T18 may not be modified during a conduction of the method. The signalling traffic on control plane may be decreased and a delay of a network entry may be reduced.

Steps S403′, S404′, S405′, S406′, S407′ and S408′ for MS2 101″′ correspond to steps S403, S404, S405, S406, S407 and S408′ for MS1 101″.

A layout of the BS_Attachment_Req/Rsp, BS_Update_Req/Rsp messages, may be described in the following and the message definitions are given from Table 1 to Table 4.

The corresponding messages may comprise the TLVs or IEs (Information Elements). The MS Info TLV comprise MS-related context in the nested IEs. And BS Info TLV comprise BS-related context in the nested IEs.

In the Tables the letter “M” indicates a mandatory TLV and the letter “0” indicates an optional TLV.

The BS_Attachment_Req message may comprise the TLVs shown in Table 1. The order of the values in Table 1 may also define the format of the BS_Attachment_Req message.

TABLE 1
BS_Attachment_Req

| IE | M/O | Notes |
|---|---|---|
| BS Info | M | Contains BS-related context in the |
| | | nested IEs. |
| >BS ID | M | BS Identifier |
| >Authenticator | M | Identifies the authenticator from which |
| ID | | BS want to obtain authorization-related |
| | | parameters. |

The BS_Attachment_Rsp message may comprise the TLVs shown in Table 2. The order of the values in Table 2 may also define the format of the BS_Attachment_Rsp message.

TABLE 2
BS_Attachment_Rsp

| IE | M/O | Notes |
|---|---|---|
| Failure | O | The Failure Indication may Indicate the |
| Indication | | reason for failure of a previous request |
| | | message. |
| BS Info | M | Contains BS-related context in the nested |
| | | IEs. |
| >BS ID | M | BS Identifier |
| >Authorization | O | The authenticator includes its authorization |
| policy support | | policy support parameter in |
| | | BS_Attachment_Rsp message. |
| >Authenticator | O | If this TLV is included, it means the default |
| ID | | authenticator assign another authenticator |
| | | for this BS. |
| >Lease value | O | The Lease value TLV may be a time |
| | | duration, a time period or a lease time to |
| | | indicate to the receiver, e.g. BS 102, the |
| | | duration how long the Authorization Policy |
| | | Support parameter or any other transmitted |
| | | parameter may be valid and may be used. |
| | | The Lease value may also be a number, |
| | | e.g. limited number of MS for which a |
| | | particular Authorization Support parameter |
| | | may be used. |

The BS_Update_Req message may comprise the TLVs shown in Table 3. The order of the values in Table 3 may also define the format of the BS_Update_Req message.

TABLE 3
BS_Update_Req

| IE | M/O | Notes |
|---|---|---|
| BS Info | M | Contains BS-related context in the |
| | | nested IEs. |
| >BS ID | M | BS Identifier |
| >Authorization | O | This TLV means the authenticator's |
| policy support | | new or actual authorization policy |
| | | support parameter. |
| >Authenticator | O | If this TLV is included, it means the |
| ID | | default authenticator assign another |
| | | authenticator for this BS. |
| >Lease value | O | |

The BS_Update_Rsp message comprise the TLVs shown in Table 4. The order of the values in Table 4 may define the format of the BS_Update_Rsp message.

TABLE 4
BS_Update_Rsp

| IE | M/O | Notes |
|---|---|---|
| Failure Indication | O | The Failure Indication may Indicate |
| | | the reason for failure of a previous |
| | | request message. |

MS_PreAttachment_Req/Rsp messages will be described in the following and the message definitions are given in Table 5 and Table 6. The order of the values in Table 5 may also define the format of the MS_PreAttachment_Req message.

TABLE 5
MS_PreAttachment_Req from BS to Authenticator

| IE | M/O | Notes |
|---|---|---|
| MS Info | M | Contains MS-related context in the nested IEs. |
| Authorization | M | In case BS MS_PreAttachment_Req message is |
| policy support | | sent after SBC-RSP, this TLV identifies the BS |
| | | cached Authorization Policy Support parameter; |
| | | otherwise this TLV identifies the MS |
| | | authorization policy |
| BS Info | O | Contains relevant Serving BS context in the |
| | | nested IEs. |
| >BS ID | O | Serving BS ID |

MS_PreAttachment_Rsp message is shown in Table 6. The order of the values in Table 6 may also define the format of the MS_PreAttachment_Rsp message.

TABLE 6
MS_PreAttachment_Rsp from Authenticator to BS

| IE | M/O | Notes |
|---|---|---|
| Failure | O | The Failure Indication may Indicate the reason |
| Indication | | for failure of a previous request message. |
| MS Info | M | Contains MS-related context in the nested IEs. |
| Authorization | O | Identifies the authorization policy. |
| policy support | | |
| >Authenticator | O | If this TLV is included, it means the default |
| ID | | authenticator assign another authenticator for |
| | | this BS. |
| BS Info | O | Contains relevant Serving BS context in the |
| | | nested IEs. |
| >BS ID | O | Serving BS ID |
| >Lease Value | O | |

One example for the Lease Value TLV may be an unsigned integer value. The Lease Value is a time duration, e.g. hour or minute, which time duration indicates to the BS 102 the duration how long the Authorization Policy Support parameter may be valid and may be used. Lease Time begins from the time of receipt of the Authorization Policy Support parameter by BS 102.

In one example the lease time length may be 2 bytes for storing the lease time. Two values for a Lease Time may be reserved as special values. A lease time value zero may mean that no caching or storing in the BS 102 is allowed. A lease time value 0xFFFF may mean that substantially no limit for the lease time exists, i.e. the lease time may substantially not expire.

The Lease Time may be a child of BS Info TLV, but it also may be included in as a child of an Authorization Policy support TLV or other location.

In other words, the Lease Value TLV may be a sub-TLV of the Authorization policy support TLV or the Lease Value TLV may be a sub-TLV of the MS Info TLV.

The Lease Value TLV or the lease time may be in a 24 hour format with a granularity of milliseconds, seconds, minutes or hours. Thus, the 2 Byte may allow to use 65536 milliseconds, 65536 seconds, 65536 minutes or 65536 hours.

It should be clear, that the present invention is not limited to the specific above messages used, and the messages here and throughout the entire invention text are presented as only one exemplary embodiment of the invention.

It should be noted that the term “comprising” does not exclude other elements or steps and the “a” or “an” does not exclude a plurality. Also elements described in association with different embodiments may be combined.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A base station apparatus, comprising:
a network attachment device sending a base station attachment signal to cause the base station apparatus to connect to an authenticator apparatus, the base station attachment signal requesting globally scoped or per-base station apparatus information from the authenticator apparatus; and
a memory storing the received globally scoped or per-base station apparatus information.

2. The base station apparatus of claim 1, wherein the network attachment device receives a base station update signal including updated globally scoped or per-base station apparatus information, and the memory stores the updated globally scoped or per-base station apparatus information.

3. The base station apparatus of claim 1, further comprising:
a terminal attachment device allowing a terminal to connect to the authenticator apparatus via the network attachment device after the globally scoped or per-base station apparatus information has been received by the network attachment device.

4. The base station apparatus of claim 3, wherein connecting the terminal to the authenticator apparatus includes sending the globally scoped or per-base station apparatus information to the terminal.

5. The base station apparatus of claim 3, wherein connecting the terminal to the authenticator apparatus includes sending a terminal identification signal by the network attachment device to the authenticator apparatus.

6. The base station apparatus of claim 1, wherein the base station apparatus is at least a base station apparatus selected from the group consisting of a WiMax™ base station, an IEEE 802.16 base station, an IEEE 802.16e base station, a GSM base station and an UMTS base station.

7. The base station apparatus of claim 1, wherein the base station attachment signal is a BS_Attachment signal, and/or wherein the base station update signal is a BS_Update signal.

8. The base station apparatus of claim 3, wherein the terminal attachment device allows a further terminal to connect to the authenticator apparatus via the terminal attachment device by sending actual globally scoped or per-base station apparatus information to the terminal.

9. The base station apparatus of claim 1, wherein connecting the base station apparatus to the authenticator apparatus is separate from connecting the terminal to the authenticator apparatus.

10. An authenticator apparatus, comprising:
a base station attachment device receiving a base station attachment signal from a base station and transmitting globally scoped or per-base station information to the base station.

11. The authenticator apparatus of claim 10, wherein the base station attachment device connects the authenticator apparatus to the base station.

12. The authenticator apparatus of claim 10, wherein the base station attachment device transmits a base station update signal including a predefined parameter to the base station after amending the predefined parameter within the authenticator apparatus, the base station update signal including updated globally scoped or per-base station apparatus information.

13. The authenticator apparatus of claim 10, wherein the globally scoped or per-base station apparatus information includes an authorization policy support parameter and/or authorization-related parameters.

14. The authenticator apparatus of claim 13, wherein the authorization policy support parameter has a lease value and/or the authorization-related parameters have a lease value.

15. The authenticator apparatus of claim 10, further comprising:
a remote terminal attachment device allowing at least one terminal to connect to the authenticator apparatus.

16. The authenticator apparatus of claim 10, wherein the authenticator apparatus is at least one apparatus selected from the group consisting of an authenticator, an Access Service Network Gateway, a Visited AAA Server and a Home AAA Server.

17. A method of connecting a base station apparatus to an authenticator apparatus, comprising:
transmitting a base station attachment signal from a network attachment device of the base station apparatus, the base station attachment signal requesting globally scoped or per-base station information from the authenticator apparatus;
receiving the globally scoped or per-base station information from the authenticator apparatus; and
storing the globally scoped or per-base station information in a memory of the base station apparatus in order to establish a communication relation between the base station apparatus and the authenticator apparatus to allow the base station apparatus to connect to the authenticator apparatus.

18. The method of claim 17, further comprising:
receiving a base station update signal in the network attachment device from the authenticator apparatus, the base station update signal including updated globally scoped or per-base station apparatus information; and
storing the updated globally scoped or per-base station apparatus information in the memory.

19. A method of connecting a terminal to an authenticator apparatus, comprising:
receiving a base station attachment signal at a base station attachment device of the authenticator apparatus; and
transmitting globally scoped or per-base station information to a base station apparatus, the globally scoped or per-base station information allowing for a connection between the terminal and the authenticator apparatus through the base station apparatus.

20. The method of claim 19, further comprising:
detecting amending of a predefined parameter within the authenticator apparatus; and
transmitting a base station update signal including the amended predefined parameter to the base station apparatus after detecting the amending of the predefined parameter, the base station update signal including updated globally scoped or per-base station apparatus information.
